(19) United States
(12) Patent Application Publication
(10) Pub. No.: US 2023/0134076 A1
(43) Pub. Date: May 4, 2023

(54) ANALYTICS AND RECOMMENDATION GENERATION BASED ON MEDIA CONTENT SHARING

(71) Applicant: Honda Motor Co., Ltd., Tokyo (JP)

(72) Inventor: Matt Komich, Lyndhurst, OH (US)

(21) Appl. No.: 17/517,192

(22) Filed: Nov. 2, 2021

(51) Int. Cl. G06N 20/00; G06F 16/21

(52) U.S. Cl. CPC G06N 20/00; G06F 16/21

(57) ABSTRACT

A server and method for analytics and recommendation generation based on media content sharing is provided. The server acquires, from a plurality of electronic devices, a plurality of data records, each including information about a plurality of data fields. Each of the plurality of data records may correspond to a media content sharing interaction. The server further applies a trained machine learning (ML) model on the acquired plurality of data records. The server further generates analytics information associated with at least one of the plurality of data fields of the plurality of data records, based on the application of the trained ML model. The server further generates one or more recommendations based on the application of the trained ML model on the generated analytics information. The server further controls the generated analytics information and the generated one or more recommendations.

### BACKGROUND

Advancements in the field of information and communications technology have led to development of various techniques for analytics and recommendation generation for media content (for example, a song, a video, or a podcast). There are various techniques that may provide various statistics related to media content consumption by users. However, typically, such statistics may not provide satisfactory or valuable insights to content creators (e.g., artists, musicians, music directors, composers, or podcast creators), sponsors, advertisers, or other stakeholders about the users, such as, listeners (for example, fans), of the media content to efficiently engage with the users.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a server for analytics and recommendation generation based on media content sharing is provided. The server may acquire from a plurality of electronic devices, a plurality of data records each including information about a plurality of data fields. Each of the plurality of data records may correspond to media content sharing interaction. The server may apply a trained machine learning (ML) model on the acquired plurality of data records. The server may generate analytics information associated with at least one of the plurality of data fields of the plurality of data records, based on the application of the trained ML model. The server may control the generated analytics information.

According to another embodiment of the disclosure, a method associated with a server is provided. The method may include acquiring, from a plurality of electronic devices, a plurality of data records each including information about a plurality of data fields. Each of the plurality of data records may correspond to media content sharing interaction. The method may further include applying a trained machine learning (ML) model on the acquired plurality of data records. The method may further include generating analytics information associated with at least one of the plurality of data fields of the plurality of data records, based on the application of the trained ML model. The method may further include controlling the generated analytics information.

According to an embodiment of the disclosure, a non-transitory computer-readable storage medium configured to store instructions that, in response to being executed, causes a server to perform operations for analytics and recommendation generation based on media content sharing is provided. The operations may include acquiring, from a plurality of electronic devices, a plurality of data records each including information about a plurality of data fields. Each of the plurality of data records may correspond to media content sharing interaction. The operations may further include applying a trained machine learning (ML) model on the acquired plurality of data records. The operations may further include generating analytics information associated with at least one of the plurality of data fields of the plurality of data records, based on the application of the trained ML model. The operations may further include controlling the generated analytics information.

### BRIEF DESCRIPTION OF THE DRAWINGS

FIG. 1 is a block diagram that illustrates an exemplary network environment for analytics and recommendation generation based on media content sharing interaction, in accordance with an embodiment of the disclosure.

FIG. 2 is a block diagram that illustrates an exemplary server of FIG. 1, in accordance with an embodiment of the disclosure.

FIGS. 3A-3F are tables that illustrate exemplary data records corresponding to media content sharing interaction, in accordance with an embodiment of the disclosure.

FIG. 4 is a diagram that illustrates exemplary operations for analytics generation based on media content sharing interaction, in accordance with an embodiment of the disclosure.

FIGS. 5A-5E are diagrams that illustrate exemplary scenarios for generated analytics and recommendations based on media content sharing interaction, in accordance with an embodiment of the disclosure.

FIG. 6 is a diagram that illustrates exemplary operations for recommendations generation based on the analytics information, in accordance with an embodiment of the disclosure.

FIG. 7 is a flowchart that illustrates exemplary method for analytics and recommendation generation based on media content sharing interaction, in accordance with an embodiment of the disclosure.

### DETAILED DESCRIPTION

Various embodiments of the present disclosure may be found in a server for automatic generation of analytics and recommendations based on media content sharing. The server may be configured to acquire, from a plurality of electronic devices (for example, a smartphone, a smartwatch, infotainment systems of vehicles, and the like), a plurality of data records, each including information about a plurality of data fields. Each of the plurality of data records may correspond to media content sharing interaction (such as, media content shared between a plurality of users).

Examples of the plurality of data fields may include, but are not limited to, demographic data fields related to users associated with the plurality of electronic devices, device data fields associated with the plurality of electronic devices, content metadata fields associated with the media content shared, contextual data fields, interaction data fields related to the media content shared, or vehicular data fields. The server may be configured to apply a trained machine learning (ML) model on the acquired plurality of data records.

Based on the application of the trained ML model, the server may be configured to automatically generate analytics information associated with at least one of the plurality of data fields of the plurality of data records. The generated analytics information may be indicative of, for example, demographic information of a plurality of users, an amount of the media content shared by the plurality of users, and information related to content metadata fields associated with the media content. In an embodiment, based on the application of the trained ML model, the server may utilize different combinations of data fields (for example, a combination of demographic data fields, content metadata fields, and vehicular data fields) of the plurality of data records, for the automatic generation of the analytics information. Thereafter, the server may be configured to control the generated analytics information.

For example, the server may be configured to transmit the generated analytics information to an electronic device associated with a content creator (for example, a musician, or a music director). The disclosed server or the electronic device may further control a display device to display the generated analytics information associated with at least one of the plurality of data fields of the plurality of data records. In an embodiment, the disclosed server may be configured to automatically generate recommendations based on an application of the trained ML model on the generated analytics information. Such recommendations may be associated with setting of marketing goals, advertisements, collaborations among artists, and the like. The analytics information and recommendations automatically generated based on various combinations of different data fields of the plurality of data records, may provide useful and valuable insights about content, artists, content creators, podcasters, listeners and/or viewers of the media content being shared. Such insights may help the content creator and/or an advertiser to improve engagement/interaction among the artists (or content creators) and the listeners (or viewers), and effectively target different listeners or viewers for an enhancement of the media content creation/distribution business.

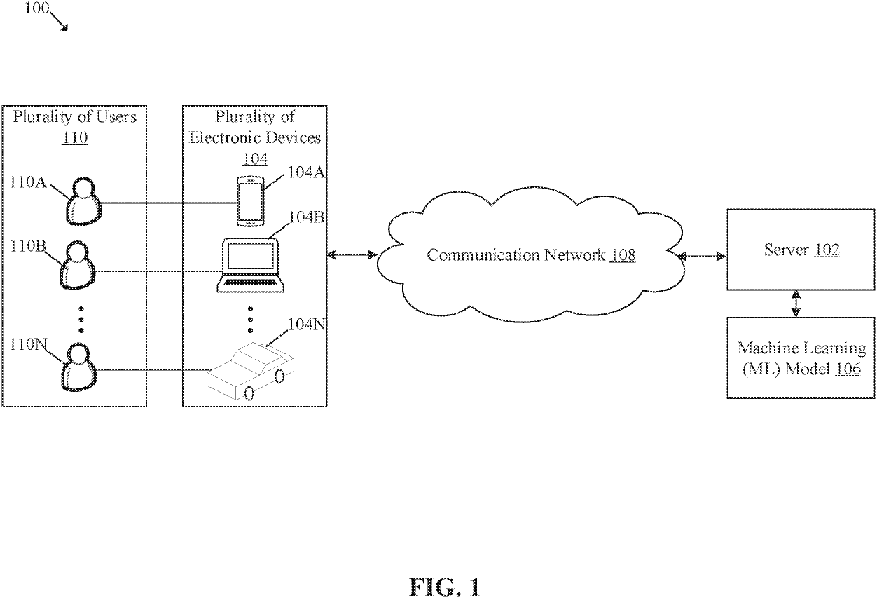

FIG. 1 is a block diagram that illustrates an exemplary network environment for analytics and recommendation generation based on media content sharing interaction, in accordance with an embodiment of the disclosure. With reference to FIG. 1, there is shown a block diagram of a network environment 100. The network environment 100 may include a server 102, a plurality of electronic devices 104, and a trained machine learning (ML) model 106. The server 102 and the plurality of electronic devices 104 may be communicatively coupled via a communication network 108. The plurality of electronic devices 104 may include a first electronic device 104A, a second electronic device 104B, ...and an Nth electronic device 104N, as shown in FIG. 1.

The N number of plurality of electronic devices 104 shown in FIG. 1 is presented merely as an example. The plurality of electronic devices 104 may include more or less than N number of electronic devices, without departure from the scope of the disclosure. There is further shown a plurality of users 110 associated the plurality of electronic devices 104. The plurality of users 110 may include a first user 110A, a second user 110B, ...and an Nth user 110N, as shown in FIG. 1. The N number of plurality of users 110 shown in FIG. 1 is presented merely as an example. The plurality of users 110 may include more or less than N number of users, without departure from the scope of the disclosure.

The server 102 may include suitable logic, circuitry, interfaces, and/or code that may be configured to generate analytics information associated with at least one of a plurality of data fields of a plurality of data records, based on an application of the trained ML model 106 on the plurality of data records. The server 102 may be further configured to control the generated analytics information. Herein, each of the plurality of data records may include information about the plurality of data fields. Each of the plurality of data records may be acquired from the plurality of electronic devices 104 and may correspond to media content sharing interaction. In some embodiments, the server 102 may be configured to generate the recommendation information based on the generated analytics information. In an embodiment, the server 102 may be implemented as a cloud server and may execute operations through web applications, cloud applications, HTTP requests, repository operations, file transfer, and the like. Other example implementations of the server 102 may include, but are not limited to, an analytics server, a content marketing server, a database server, a file server, a content server, a web server, an application server, a mainframe server, or a cloud computing server. In at least one embodiment, the server 102 may be implemented as a plurality of distributed cloud-based resources by use of several technologies that are well known to those ordinarily skilled in the art. A person with ordinary skill in the art will understand that the scope of the disclosure may not be limited to the implementation of the server 102 and the plurality of electronic devices 104 as two separate entities. In certain embodiments, the functionalities of the server 102 can be incorporated in its entirety or at least partially in at least one of the plurality of electronic devices 104, without a departure from the scope of the disclosure.

The plurality of users 110 may be associated with the plurality of electronic devices 104. Each user (such as, the first user 110A) may be associated with a respective electronic device (such as, the first electronic device 104A). For example, the first user 110A may be a person who shares media content via the first electronic device 104A with another user (such as the second user 110B associated with the second electronic device 104B). For example, each of the plurality of users 110 may be an owner of the corresponding electronic device of the plurality of electronic devices 104.

The plurality of electronic devices 104 may include suitable logic, circuitry, code, and/or interfaces that may be configured to reproduce and share media content among the plurality of users 110. Each of the plurality of electronic devices 104 may be associated with corresponding user of the plurality of users 110. For example, the first user 110A, the second user 110B, ... and the Nth user 110N may be associated with the first electronic device 104A, the second electronic device 104B, ... and the Nth electronic device 104N, respectively. In an example, the first user 110A may be a person who shares media content via the first electronic device 104A. Examples of the plurality of electronic devices 104 may include, but are not limited to, a smartphone, a mobile phone, a tablet, a laptop, a gaming device, a computer workstation, a handheld device (such as a smartphone or a tablet), a portable consumer electronic (CE) device, a wearable haptic device, a head-mounted display (such as an eXtended Reality (XR) display or a helmet with a Head-up Display (HUD) or an integrated display panel), a wearable computing device (such as a smart watch) or another server (i.e. different from the server 102).

In certain scenarios, one or more of the plurality of electronic devices 104 may be installed on or used inside a vehicle. For example, as shown in FIG. 1, the Nth electronic device 104N may correspond to a display device or an automated driver assistance system (ADAS) or an infotainment system installed in a vehicle or an electronic device used inside the vehicle. In such case, the examples of the electronic device may include, but are not limited to, a vehicle control system, an in-vehicle infotainment (IVI) system, an in-car entertainment (ICE) system, an automotive Head-up Display (HUD), an automotive dashboard, an embedded device, a smartphone, or a human-machine interface (HMI).

The electronic device may be included or integrated in the vehicle. The vehicle may be a non-autonomous vehicle, a semi-autonomous vehicle, or a fully autonomous vehicle, for example, as defined by National Highway Traffic Safety Administration (NHTSA). Examples of the vehicle may include, but are not limited to, a two-wheeler vehicle, a three-wheeler vehicle, a four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The vehicle may be a system through which the rider (for example, a user, such as, the first user 110A) may travel from a start point to a destination point.

Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell based car, a solar powered-car, or a hybrid car. It may be noted here that the two-wheeler vehicle and the four-wheeler vehicle are merely described as examples in FIG. 1. The present disclosure may be also applicable to other types of two-wheelers (e.g., a scooter) or four-wheelers. The description of other types of the vehicle has been omitted from the disclosure for the sake of brevity.

The Machine Learning (ML) model 106 may be trained on an analytics information generation task to generate the analytics information associated with at least one of the plurality of data fields of the plurality of data records. The ML model 106 may be a classifier model which may be trained to identify a relationship between inputs, such as features in a training dataset (like the plurality of data fields), and output labels, such as the analytics information associated with the plurality of data fields of the data records. The ML model 106 may be defined by its hyper-parameters, for example, number of weights, cost function, input size, number of layers, and the like. The parameters of the ML model 106 may be tuned, for example, the weights may be updated, so as to move towards a global minima of a cost function for the ML model 106. After several epochs of the training on the feature information in the training dataset, the ML model 106 may be trained to output a classification result for a set of inputs. The classification result may be indicative of a class label (a class label associated with the analytics information) for each input of the set of inputs (e.g., input features extracted from the acquired plurality of data records).

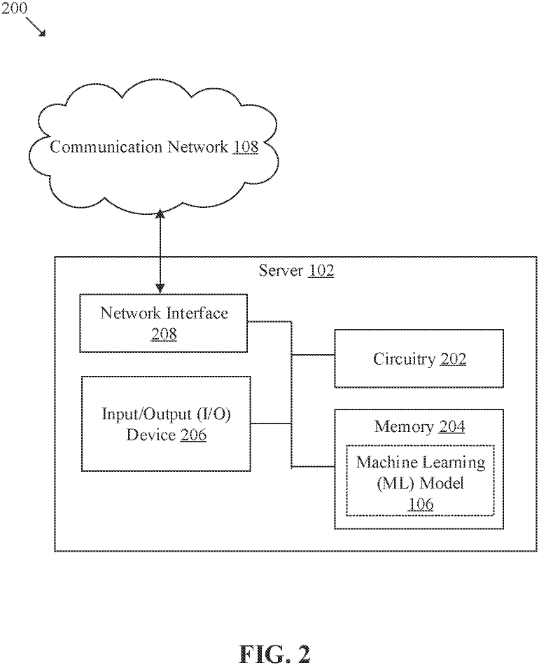

The ML model 106 may include electronic data, which may be implemented as, for example, a software component of an application executable on the server 102. The ML model 106 may rely on libraries, external scripts, or other logic/instructions for execution by a processing device, such as, circuitry of FIG. 2. The ML model 106 may include code and routines configured to enable a computing device, such as the server 102, to perform one or more operations to generate the analytics information. Additionally, or alternatively, the ML model 106 may be implemented using hardware including a processor, a microprocessor (e.g., to perform or control performance of one or more operations), a field-programmable gate array (FPGA), or an application-specific integrated circuit (ASIC). Alternatively, in some embodiments, the ML model 106 may be implemented using a combination of hardware and software. Examples of the ML model 106 may include, but are not limited to, a regression model (such as, a multi-variate logistic or linear regression model), a decision tree model, a random forest, a gradient boosted tree, or a I Bayes.

In an embodiment, the ML model 106 may be a neural network model. The neural network model may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset.

Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to same or a different same mathematical function. In training of the neural network, one or more parameters of each node of the neural network may be updated based on whether an output of the final layer for a given input (from the training dataset) matches a correct result based on a loss function for the neural network. The above process may be repeated for same or a different input till a minima of loss function may be achieved and a training error may be minimized. Several methods for training are known in art, for example, gradient descent, stochastic gradient descent, batch gradient descent, gradient boost, meta-heuristics, and the like. Examples of the neural network may include, but are not limited to, a deep neural network (DNN), a convolutional neural network (CNN), an artificial neural network (ANN), a CNN-recurrent neural network (CNN-RNN), a Long Short Term Memory (LSTM) network based RNN, CNN+ANN, LSTM+ANN, a fully connected neural network, a Connectionist Temporal Classification (CTC) based RNN, and/or a combination of such networks. In some embodiments, the learning engine_ may include numerical computation techniques using data flow graphs. In certain embodiments, the neural network may be based on a hybrid architecture of multiple Deep Neural Networks (DNNs).

The communication network 108 may include a communication medium through which the server 102 and the plurality of electronic devices 104 may communicate with one another. Examples of the communication network 108 may include, but are not limited to, the Internet, a cloud network, a Wireless Local Area Network (WLAN), a Wireless Fidelity (Wi-Fi) network, a Personal Area Network (PAN), a Local Area Network (LAN), a telephone line (POTS), and/or a Metropolitan Area Network (MAN), a mobile wireless network, such as a Long-Term Evolution (LTE) network (for examp^{le}, 4th Generation °r 5th Generation (5G) mobile network (i.e., 5G New Radio)). Various devices in the network environment 100 may be configured to connect to the communication network 108, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11s, IEEE 802.11g, multi-hop communication, wireless access point (AP), device to device communication, cellular communication protocols, or Bluetooth (BT) communication protocols, or a combination thereof.

In operation, the server 102 may be configured to receive a user input to activate an analytics generation mode. In such a mode, the server 102 may be configured to perform a set of operations to generate the analytics information based on media content sharing interactions (i.e. indicating data records related to media content sharing). A description of such operation is provided herein.

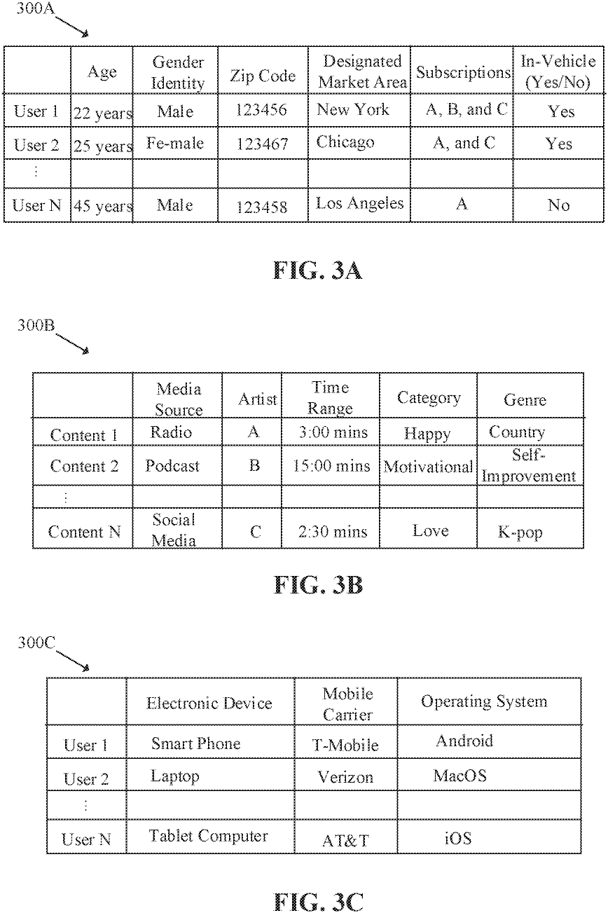

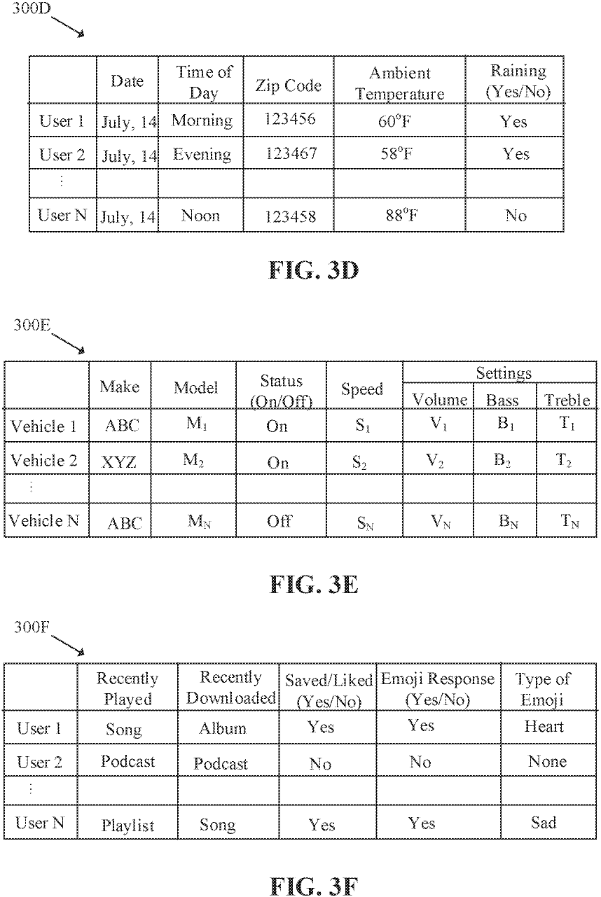

At any time-instant, the server 102 may be configured to acquire, from the plurality of electronic devices 104, a plurality of data records. Each of the acquired plurality of data records may include information about a plurality of data fields. Examples of the plurality of data fields may include, but are not limited to, demographic data fields related to users associated with the plurality of electronic devices 104, device data fields associated with the plurality of electronic devices 104, content metadata fields associated with the media content shared, contextual data fields, interaction data fields related to the media content shared, or vehicular data fields. Details related to the plurality of data fields is provided, for example, in FIGS. 3A, 3B, 3C, 3D, 3E, and 3F.

Each of the plurality of data records may correspond to media content sharing interaction. The media content may correspond to any digital data that may be rendered, streamed, broadcasted, and/or stored on any electronic device or storage. Examples of the media content may include, but are not limited to, images (such as overlay graphics), animations (such as 2D/3D animations or motion graphics), audio/video data (such as, songs, music, videos, or movies), or Internet content (e.g., streaming media, downloadable media, Webcasts, podcasts, and the like). In an embodiment, the server 102 may be configured to analyze the media content sharing interactions (i.e. indicating the plurality of data records) of the plurality of users 110. The plurality of data records may indicate different media content shared among the plurality of users 110. By way of example, and not limitation, the media content sharing interaction may include media content sharing using a cloud server, a social media website, an API (i.e., Application Programming Interface), a data aggregator, a peer-to-peer content sharing application, and the like.

In an instance, the first user 110A may share first media content of an artist ‘A’ with the second user 110B, who may be a listener or a fan of the artist ‘A’. For example, such sharing of the first media content may be referred to as the media content sharing interaction. Other examples of the media content sharing interaction are also provided herein. In an example, the second user 110B may stream other media content associated with the artist ‘A’, such as, a playlist of the artist ‘A’, repeatedly for a period of time (such as, next 6 months). In another example, the second user 110B may share the first media content associated with the artist ‘A’ with other users (such as friends, family, or colleagues). Such media content sharing interaction with respect to the media content associated with the artist ‘A’ may be indicative of an engagement of the users with the media content associated with the artist ‘A’.

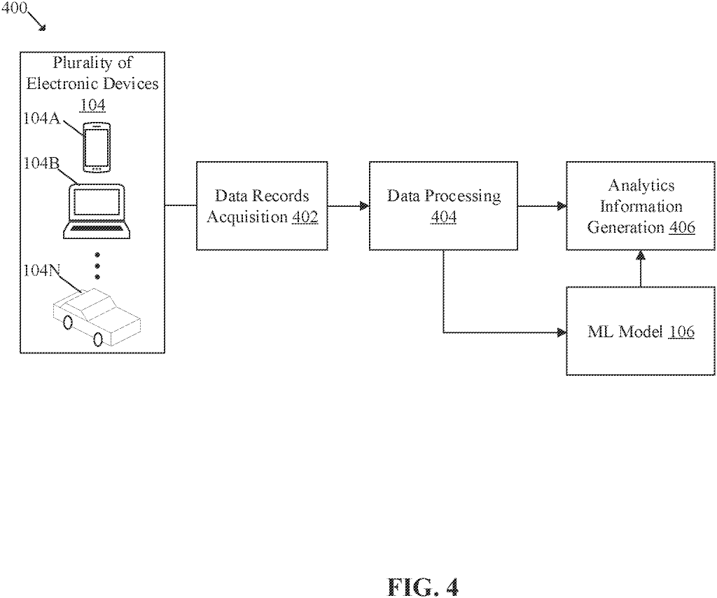

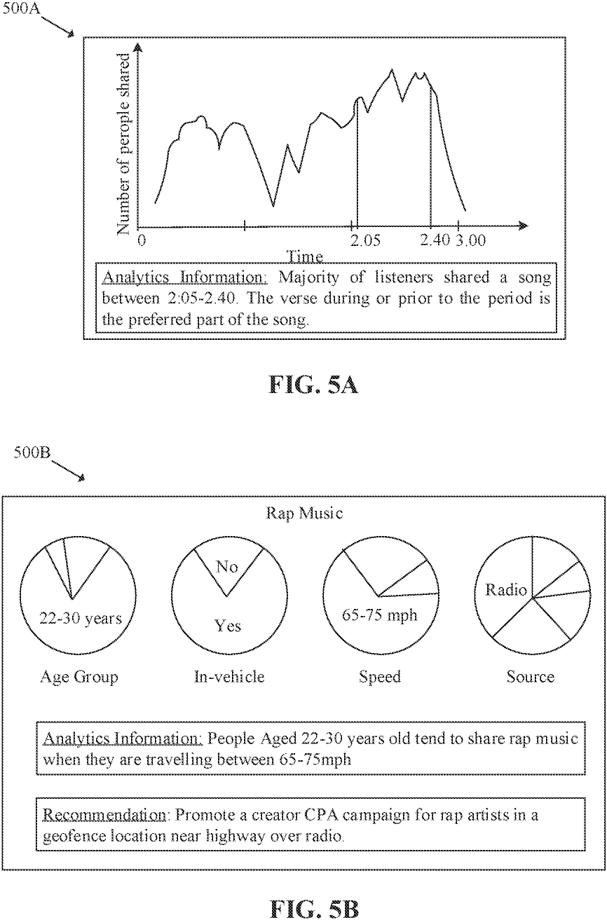

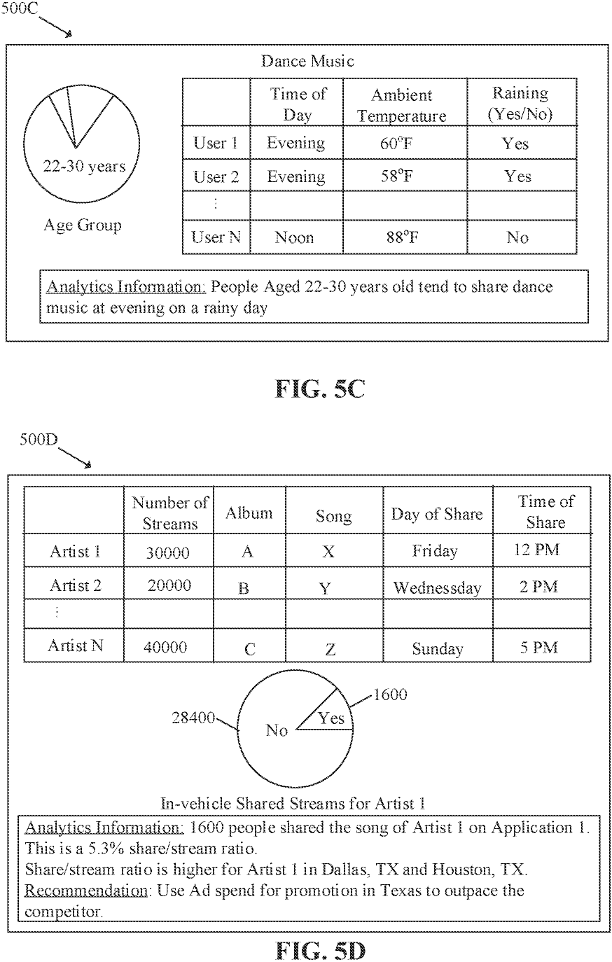

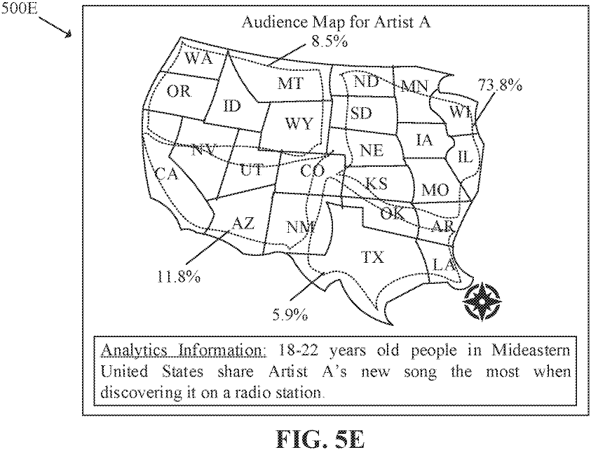

The server 102 may be configured to apply the trained machine learning (ML) model 106 on the acquired plurality of data records. Based on the application of the trained ML model 106, the server 102 may be configured to generate analytics information associated with at least one of the plurality of data fields of the plurality of data records. For example, the generated analytics information may be indicative of demographic information of the plurality of users 110, an amount of the media content shared by the plurality of users 110, and information related to content metadata fields associated with the media content. The analytics information may be generated based on different combinations of data fields of the plurality of data records. Details related to the generation of the analytics information is provided, for example, in FIG. 4. Thereafter, the server 102 may be configured to control the generated analytics information. Details related to the control of the generated analytics information is provided for example, in FIGS. 5A, 5B, 5C, 5D, and 5E.

For example, the server 102 may be configured to transmit the generated analytics information to an electronic device associated with a content creator (for example, a musician, or a music director). The server 102 or the electronic device may control a display device to display the generated analytics information associated with at least one of the plurality of data fields of the plurality of data records. The display device (not shown) may include suitable logic, circuitry, and/or interfaces that may be configured to display the generated analytics information. In an embodiment, the display device may be externally coupled with the server 102 or the electronic device via an I/O interface or a network interface. In another embodiment, the display device may be integrated into the server 102 or the electronic device. The display device may be realized through several known technologies such as, but not limited to, a Liquid Crystal Display (LCD) display, a Light Emitting Diode (LED) display, a plasma display, or an Organic LED (OLED) display, or other display technologies.

In an embodiment, the disclosed server 102 may be configured to generate recommendations based on an application of the trained ML model 106 on the generated analytics information. Such recommendations may be associated with setting of marketing goals, advertisements, collaborations among various artists, and the like. The generated analytics information and recommendations may provide useful and valuable insights about (but not limited to) content, artists, content creators, podcasters, and/or listeners/viewers. Further, such insights may help the content creator and/or an advertiser to improve engagement/interactions between the artists/creators and the listeners/viewers, and also to effectively target different listeners/viewers of the media content to further enhance the content creation/distribution business.

FIG. 2 is a block diagram that illustrates an exemplary server of FIG. 1, in accordance with an embodiment of the disclosure. FIG. 2 is explained in conjunction with elements from FIG. 1. With reference to FIG. 2, there is shown a block diagram 200 of the server 102. The server 102 may include circuitry 202, a memory 204, an Input/Output (I/O) device 206, and a network interface 208. The network interface 208 may connect the server 102 with the plurality of electronic devices 104, via the communication network 108.

The circuitry 202 may include suitable logic, circuitry, interfaces, and/or code that may be configured to execute program instructions associated with different operations to be executed by the server 102. For example, the different operations may include, but are not limited to, acquisition of the plurality of data records, the application of the trained ML model 106 on the acquired plurality of data records, the generation of the analytics information, and the control of the generated analytics information. The circuitry 202 may include one or more specialized processing units, which may be implemented as a separate processor. In an embodiment, the one or more specialized processing units may be implemented as an integrated processor or a cluster of processors that may be configured to perform the functions of the one or more specialized processing units, collectively. The circuitry 202 may be implemented based on a number of processor technologies that are known in the art. Examples of implementations of the circuitry 202 may be, but are not limited to, an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store program instructions to be executed by the circuitry 202. In at least one embodiment, the memory 204 may be configured to store the trained machine learning (ML) model 106. The memory 204 may be configured to store one or more of, but not limited to, the plurality of data records, the generated analytics information, and the generated one or more recommendations. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. The I/O device 206 may include various input and output devices, which may be configured to communicate with the circuitry 202. In an example, the server 102 may receive (via the I/O device 206) the user input indicative of the data records. The server 102 may control the I/O device 206 to output the generated analytics information, and the generated one or more recommendations. Examples of the I/O device 206 may include, but are not limited to, a touch screen, a keyboard, a mouse, a joystick, a display device, a microphone, or a speaker.

The network interface 208 may include suitable logic, circuitry, interfaces, and/or code that may be configured to facilitate communication between the server 102 and the plurality of electronic devices 104, via the communication network 108. The network interface 208 may be implemented by use of various known technologies to support wired or wireless communication of the server 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via a wired communication or a wireless communication or a combination thereof with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The operations of the circuitry 202 are further described, for example, in FIGS. 3A, 3B, 3C, 3D, 3E, 3F, 4, 5A, 5B, 5C, 5D, 5E, and 6. It may be noted that the server 102 shown in FIG. 2 may include various other components or systems. The description of the other components or systems of the server 102 has been omitted from the disclosure for the sake of brevity.

FIGS. 3A-3F are tables that illustrates exemplary data records corresponding to media content sharing interaction, in accordance with an embodiment of the disclosure. FIGS. 3A-3F are explained in conjunction with elements from FIGS. 1, and 2. With reference to FIG. 3A, there is shown a table 300A. The table 300A may include demographic data fields related to users (such as the plurality of users 110) associated with the plurality of electronic devices 104.

Examples of the demographic data fields related to the users may include, but are not limited to, an age group, an age, a date of birth, a birth month, a birth year, a gender, a geographical location, a designated market area, subscription type from digital streaming provider, or an in-vehicle status related to the users associated with the plurality of electronic devices 104. As shown in FIG. 3A, the table 300A may include columns such as, an age, a gender identity, a zip code, a designated market area, a subscription, and in-vehicle. The table 300A may include multiple columns, where each column may correspond to the demographic data fields related to users (such as a “User 1”, “User 2”, ... and “User N”) of the plurality of electronic devices 104. Different rows in the table 300A may indicate data records for different demographic data fields. As shown in the table 300A of FIG. 3A, for example, the ages of the users, such as, “User 1”, User 2”, ... and “User N”, may be “22 years”, “25 years”, ... and “45 years”, respectively. Further, the gender identity of the users may be “Male”, “Fe-male”, ... and “Male”.

The geographical location of a user may correspond to geolocation of the users. For example, the first electronic device 104A may be configured to receive a user input indicative of information associated with the geographical location related to the first user 110A. The user input may specify a country, a state, a city, a province, a postal code, or a zip code of the first user 110A. In some embodiments, the first electronic device 104A may include a location sensor (not shown), to acquire the information about with the geographical location related to the first user 110A, at the time of media content sharing. The location sensor may include logic, circuitry, code and/or interfaces that may be configured to acquire the information about with the geographical location related to the first user 110A. The first electronic device 104A may be configured to transmit the acquired information to the circuitry 202 of the server 102. Examples of the location sensor may include, but are not limited to, a Global Navigation Satellite System (GNSS)-based sensor and a mobile positioning system (such as a system that uses LTE positioning protocol). As shown in the table 300A, “123456”, “123467”, ... and “123458” are provided as exemplary row values for the zip code.

The designated market area may include geographical regions associated with media market related to the users. As shown in the table 300A, “New York”, “Chicago”, ... and “Los Angeles” are provided as exemplary row values for the designated market area. The subscription type from digital streaming provider may indicate subscriptions related to the media content provider that may be purchased by the users of the plurality of electronic devices 104. Such subscriptions may allow to perform the media content sharing interaction. As shown in the table 300A, “A, B, and C”, “A, and C”, ... and “A” are provided as exemplary row values for the subscriptions. The in-vehicle status related to the users associated with the plurality of electronic devices 104 may correspond to a status that may indicate whether or not a user is inside a vehicle when the media content sharing interaction is performed. The users may either be a driver or a passenger of the vehicle. As shown in the table 300A, “Yes”, “Yes”, ... and “No” are provided as exemplary row values for the in-vehicle status. For example, the “User 1” may perform the media content sharing interaction inside a vehicle associated with the “User 1”. It may be noted that the data associated with the demographic data related to the users shown in FIG. 3A is presented merely as exemplary values of the data. The present disclosure may be also applicable to other experimental data or values in various formats, without departure from the scope of the disclosure. A description of other experimental data or values has been omitted from the disclosure for the sake of brevity.

With reference to FIG. 3B, there is shown a table 300B. The table 300B may include content metadata fields associated with the media content shared. Examples of the content metadata fields associated with the media content shared may include, but are not limited to, a media source, a type of media content, an album name, a name of media content, a playlist name of media content, a playlist category, a name of episode of media content (like podcast), a name of host name of media content, a name of network provider of media content, a content time period, a time duration at which media content is shared, a genre, a sub-genre, an interest, or a mood associated with the media content shared. As shown in FIG. 3B, the table 300B may include columns such as a media source, an artist, a time range, a category, and a genre. The table 300B may include multiple columns, where each column may correspond to the content metadata fields associated with the media content shared (such as, “Content 1”, “Content 2”, ... and “Content N”). Different rows in the table 300B may indicate data records for different content metadata fields.

The media source associated with the media content shared may correspond to a source or media platform from where the media content may be shared by the content creator/distributor, or the source or media platform from which the media content may be discovered by the end users. In other words, the media source may refer to a source where the content creator may launch, broadcast, or stream the media content for the end users. Examples of the media source may include, but are not limited to, a satellite service provider, a digital streaming provider, a radio network provider, or Internet service provider. As shown in the table 300B, “Radio”, “Podcast”, ... and “Social Media” are provided as exemplary row values (i.e. data records) for the media source data field. The type of media content may include, but is not limited to, audio/video content, or Internet content (e.g., streaming media, downloadable media, Webcasts, podcasts, and the like). For example, the type of media content may correspond to a song or a podcast. In an example, in case the type of media content is a song, the content metadata fields may include, but not are limited to, an artist, an album, a title, a playlist, or a playlist category associated with the song. In another example, in case the type of media content is a podcast, the content metadata fields may include, but are not limited to, an episode number/name, host name(s), a title, or a category associated with the podcast. As shown in the table 300B, “A”, “B”, ... and “C” are provided as exemplary row values (i.e. data records) for the artist data field.

The content time period may include a time duration (or a time range) associated with the media content shared. As shown in the table 300B, “3:00 mins”, “15:00 mins”, ... and “2:30 mins” are provided as exemplary row values (i.e. data records) for the time range data field. The time duration at which media content is shared may include a timestamp corresponding to the media content at which the media content sharing interaction associated with the media content is performed. For example, if the media content is shared at a timestamp of 1:40 mins (i.e., after completion of a playback of 1:40 min of the media content), the time duration (or the time range) for such media content may be 1:40 mins.

The genre of the media content may include, but is not limited to, a rock genre, a blues genre, a country genre, a Caribbean genre, a folk genre, a pop genre, a jazz genre, a classical genre, a hip hop genre, an electronic genre, a rhythm & blues genre, a soul genre, an action genre, an adventure genre, a biopic genre, a children genre, a comedy genre, a crime/detective/spy genre, a documentary genre, a drama genre, a horror genre, a family genre, a fantasy genre, a historical genre, a matured content genre, a paranormal genre, or a talk show genre. As shown in the table 300B, “Country”, “self-improvement”, ... and “K-pop” are provided as exemplary row values (i.e. data records) for the genre data field. The mood may be related to a category of an emotional state associated with the media content. For example, the mood may include, but is not limited to, a happy mood, an angry mood, a sad mood, a party mood, a romantic mood, a love mood, or a motivational mood.

As shown in the table 300B, “happy”, “motivational”, ... and “love” are provided as exemplary row values (i.e. data records) for the category data field. It may be noted that the data records associated with the content metadata fields associated with the media content shared shown in FIG. 3B is presented merely as exemplary values of the data. The present disclosure may be also applicable to other experimental data or values in various formats, without departure from the scope of the disclosure. A description of other experimental data or values has been omitted from the disclosure for the sake of brevity.

With reference to FIG. 3C, there is shown a table 300C. The table 300C may include device data fields associated with the plurality of electronic devices 104. Examples of the device data fields associated with the plurality of electronic devices 104 may include, but are not limited to, a type of device, a mobile carrier, or specification information associated with the plurality of electronic devices 104. As shown in FIG. 3C, the table 300C may include columns such as, an electronic device, a mobile carrier, and an operating system. The table 300C may include multiple columns, where each column may correspond to the device data fields associated with the plurality of electronic devices 104 related to users (such as, the “User 1”, the “User 2”, ... and “User N”). Different rows in the table 300C may indicate data records for different device data fields. As shown in the table 300C of FIG. 3C, for example, “smart phone”, “laptop”, ... and “tablet computer” are provided as exemplary row values for the electronic device. Further, “T-Mobile”, “Verizon”, ... and “AT&T” are provided as exemplary row values for the mobile carrier.

The specification information may correspond to a device specification associated with the electronic device such as, but not limited to, a model of the device, an operating system, or other hardware/software specifications associated with the electronic device. As shown in the table 300C, “Android”, “MacOS”, ... and “iOS” are provided as exemplary row values for the operating system. It may be noted that the data associated with the device data fields shown in FIG. 3C is presented merely as exemplary values of the data. The present disclosure may be also applicable to other experimental data or values in various formats, without departure from the scope of the disclosure. A description of other experimental data or values has been omitted from the disclosure for the sake of brevity.

With reference to FIG. 3D, there is shown a table 300D. The table 300D may include contextual data fields. Examples of the contextual data fields may include, but are not limited to, a temperature range, an ambient temperature, a date, a time, a weather condition, a rain status, or a geographical location. As shown in FIG. 3D, the table 300D may include columns such as, a date, a time of day, a zip code, an ambient temperature, and raining (yes/no). The table 300D may include multiple columns, where each column may correspond to the contextual data fields related to users (such as the “User 1”, the “User 2”, ... and the “User N”). Different rows in the table 300D may indicate data records for different contextual data fields.

The date may include, but not limited to, a day of week, a month, a day of month, a year, or a date on which the media content sharing interaction may be performed. As shown in the table 300D, “July 14” is provided as exemplary row value for the date. The time of day may include, but is not limited to, a time of day, or range of time of day at which the media content sharing interaction may be performed. As shown in the table 300D, “Morning”, “Evening”, ... and “Noon” is provided as exemplary row value for the time of day. There is further shown, “123456”, “123467”, ... and “123458” as exemplary row values for the zip code indicating the geo-location at which media content sharing interaction may be performed.

The ambient temperature may correspond to a temperature of surrounding environment when the media sharing interaction is performed. As shown in the table 300D, “60° F.”, “58° F.”, ... and “88° °F” are provided as exemplary row values for the ambient temperature. The raining status may correspond to a status that may indicate whether or not it is raining when the media content sharing interaction is performed. As shown in the table 300D, “Yes”, “Yes”, ... and “No” are provided as exemplary row values for the raining status. It may be noted that the data associated with the contextual data fields shown in FIG. 3D is presented merely as exemplary values of the data. The present disclosure may be also applicable to other experimental data or values in various formats, without departure from the scope of the disclosure. A description of other experimental data or values has been omitted from the disclosure for the sake of brevity.

With reference to FIG. 3E, there is shown a table 300E. The table 300E may include vehicular data fields. Examples of the vehicular data fields may include, but are not limited to, a state of a vehicle in which the media content sharing interaction is performed, a model of the vehicle, a speed of the vehicle, geo-location information of the vehicle, or setting information associated with an infotainment device of the vehicle. As shown in FIG. 3E, the table 300E may include columns such as a make, a model, a status, a speed, and settings. The table 300E may include multiple columns, where each column may correspond to the vehicular data fields associated with vehicles (such as, a “Vehicle 1”, a “Vehicle 2”, ... and a “Vehicle N”) in which the media content sharing may be performed. Different rows in the table 300E may indicate data records for different vehicular data fields.

The vehicular data may be acquired using one or more sensors (not shown) associated with the vehicle. In an embodiment, the one or more sensors may include at least one of, but are not limited to, a location sensor, a speed sensor, an inertial measurement unit (IMU), a heat sensor, a pressure sensor, an image sensor, a rain sensor, a proximity sensor, a current sensor, or a humidity sensor. Such sensors may be configured to acquire the vehicular data. For instance, the speed sensor may include suitable logic, circuitry, interfaces, and/or code that may detect a speed of the vehicle. The speed for different time-stamps may be recorded in a database stored in the memory 204. As shown in the table 300E, “S₁”, “S₂”, ... and “S_{N}” are provided as exemplary row values for the speed (in Km/hrs or in Miles/hrs).

In an embodiment, the vehicle may include a telematics unit, that may be configured to control tracking, diagnostics, and communication of the vehicle with the server 102. The telematics unit may include a global navigation satellite system (GNSS) receiver unit that may detect a location of the vehicle. The telematics unit may further include one or more interfaces for communication, for example, Global System for Mobile Communications (GSM) interface, General Packet Radio Service (GPRS) interface, Long-Term Evolution (LTE) interface, Vehicle-to-Everything (V2X), Cellular-V2X, and the like. The telematics unit may further include one or more processing units, for example, a microcontroller, a microprocessor, a field programmable gate array (FPGA), and the like.

As shown in the table 300E of FIG. 3E, “ABC”, “XYZ”, ... and “ABC” are provided as exemplary row values (i.e. data records) for the make (i.e. data field) of the vehicles; and “M₁”, “M₂”, ... and “M_{N}” are provided as exemplary respective row values of the model (i.e. data field) of the vehicles. The status may indicate whether or not the vehicle is in operational state when the media content sharing interaction is performed. As shown in the table 300E, “On”, “On”, ... and “Off” are provided as exemplary row values for the status ((i.e. data field) of the vehicle.

The setting information associated with the infotainment device of the vehicle may include, but is not limited to, a volume setting, a frequency setting, a bass setting, or a treble setting. For example, the volume setting may indicate a value of an amplitude or a level of the volume (in dB) of the infotainment device when the media content sharing interaction is performed by a particular user. The volume setting may include audio amplitude values, (such as, “V₁”, “V₂”, ... and “V_{N}” in volts or dB), as shown in various rows of the table 300E. Further, the bass setting may include frequency values or ranges (such as, “B₁”, “B₂”, ... and “B_{N}”) as shown in various rows of the table 300E. Further, the treble setting may include values or ranges of audio tones whose frequencies or ranges may correspond to higher end of a human hearing ability, (such as, “T₁”, “T₂”, ... and “T_{N}”) as shown in various rows of the table 300E. It may be noted that the data associated with the vehicular data fields shown in FIG. 3E is presented merely as exemplary values of the data. The present disclosure may be also applicable to other experimental data or values in various formats, without departure from the scope of the disclosure. A description of other experimental data or values has been omitted from the disclosure for the sake of brevity.

With reference to FIG. 3F, there is shown a table 300F. The table 300F may include interaction data fields related to the media content shared. As shown in FIG. 3F, the table 300F may include columns such as, but is not limited to, recently played, recently downloaded, saved/liked, emoji response, and a type of emoji. The table 300F may include multiple column, where each column may correspond to the interaction data fields related to users (such as a “User 1”, “User 2”, ... and “User N”). Different rows in the table 300F may indicate data records for different interaction data fields. As shown in the table 300F of FIG. 3F, “song”, “podcast”, ... and “playlist” are provided as exemplary row values for the recently played data field and “album”, “podcast”, ... and “song” are provided as exemplary row values for the recently downloaded data field. In some embodiments, the data records for the recently played and the recently downloaded data fields may indicate information about a particular media content (like name, artist, episode, etc).

The saved/ liked may correspond to a status indicative of whether or not the media content is saved/liked by one or more users. As shown in the table 300F, “Yes”, “No”, ... and “Yes” are provided as exemplary row values (i.e. data records) for the “saved/ liked” data field. The emoji response may correspond to a status indicative of whether or not an emoji response is provided for particular media content shared. As shown in the table 300F, “Yes”, “No”, ... and “Yes” are provided as exemplary row values (i.e. data records) for the emoji response data field. The type of emoji may include, but is not limited to, a happy emoji, a disgust emoji, a sad emoji, surprise emoji, excited emoji, anger emoji, or love emoji that may be shared in response of the media content sharing interaction. As shown in the table 300F, “heart”, “None”, ..., “sad” are provided as exemplary row values (i.e. data records) for the emoji response data field. It may be noted that the data associated with the interaction data fields shown in FIG. 3F is presented merely as exemplary values of the data. The present disclosure may be also applicable to other experimental data or values in various formats, without departure from the scope of the disclosure. A description of other experimental data or values has been omitted from the disclosure for the sake of brevity.

Examples of sources through which the media content may be shared may include, but are not limited to, a direct message source (for example, through a messenger application) of the media content, a feed source (for example, through a social media post) of the media content, or a friend source (for example, from a friend or acquaintance on a social media platform) of the media content. The interaction data fields related to the shared media content may further include, but are not limited to, a recently played song, a recently played podcast, a recently played playlist, a recently played album, a recently downloaded song, a recently downloaded podcast, a recently downloaded playlist, a recently downloaded album, a last saved/liked song, a last saved/liked podcast, a last saved/liked playlist, a last saved/liked album, a most played track of a week, a most played album of a week, a most played podcast of a week, a most played playlist of a week, a most played track of a month, a most played album of a month, a most played podcast of a month, a most played playlist of a month, a recently followed artist, or a recently followed podcast.

The interaction data fields related to recipient(s) of the media content sharing interactions performed through a common application (such as, the content sharing application, for example, a social media platform), may include, but are not limited to, a length of time before a message is viewed (seconds, minutes, days), a length of time before a song is streamed (seconds, minutes, days), a length of time before podcast episode is streamed (seconds, minutes, days), whether a song is saved/liked (yes or no), whether a podcast episode is saved/liked (yes or no), a voice response (yes or no), a length of a voice response (minutes and seconds), a range of time of a voice response (minutes and seconds), an emoji response (yes or no), or a type of emoji shared.

FIG. 4 is a diagram that illustrates exemplary operations for analytics generation based on media content sharing interaction, in accordance with an embodiment of the disclosure. FIG. 4 is explained in conjunction with elements from FIGS. 1, 2, 3A, 3B, 3C, 3D, 3E, and 3F. With reference to FIG. 4, there is shown a block diagram 400 that illustrates exemplary operations from 402 to 406. The exemplary operations may be executed by any computing system, for example, by the server 102 of FIG. 1 or by the circuitry 202 of FIG. 2.

At 402, data records may be acquired. In an embodiment, the circuitry 202 of the server 102 may be configured to acquire, from a plurality of electronic devices (such as the plurality of electronic device 104), a plurality of data records, each including information about a plurality of data fields. The plurality of data records may be acquired from one or more sensors (not shown) associated with the plurality of electronic devices 104. Additionally, or alternatively, the plurality of data records may be acquired from a data source other than the one or more sensors. The data source may include, for example, a memory (not shown) associated with the plurality of electronic devices 104, a cloud server, a social media website, an API (i.e., Application Programming Interface), a data aggregator, and the like.

Each of the plurality of data records may correspond to media content sharing interaction. In words, information (for different data fields) in the plurality of data records may indicate that media content is shared between at least two users or customers (like listeners/viewers of the media content). As shown in FIG. 4, for example, the plurality of data records may be acquired from the plurality of electronic devices 104 (for example, a smartphone, a laptop, or an infotainment system of a vehicle). The acquired plurality of data records may include, for example, demographic data related to users, device data associated with the plurality of electronic devices 104, content metadata associated with the media content shared, contextual data, interaction data related to the media content shared, or vehicular data. Details related to the acquired plurality of data records each including information/data about the plurality of data fields is described, for example, in FIGS. 3A-3F. In some embodiments, each of the plurality of electronic devices 104 may transmit one or more data records when any media content sharing interaction is performed by corresponding electronic device. In some embodiments, the corresponding electronic device may store one or more data records of one or more sharing interactions performed for a particular time period (say in a day, a week, or a month) and transmit the stored one or more data records to the server 102 based on the completion of the time period. In some embodiments, the server 102 may transmit a request to the plurality of electronic devices 104 (i.e. registered devices) to acquire the plurality of data records that may be stored in the corresponding electronic device for a particular number of media content sharing interactions (i.e. indicated in the transmitted request).

At 404, data processing may be performed. In an embodiment, the circuitry 202 may be configured to execute one or more data processing operations on the acquired plurality of data records, to generate processed data. For example, the circuitry 202 may employ data processing operations to extract information about the plurality of data fields from the acquired plurality of data records. The plurality of data fields may include, but are not limited to, demographic data fields related to users associated with the plurality of electronic devices 104, device data fields associated with the plurality of electronic devices 104, content metadata fields associated with the media content shared, contextual data fields, interaction data fields related to the media content shared, or vehicular data fields. By way of example, and not limitation, the data processing operations may include, but is not limited to, a data ingestion operation, a data normalization operation, a data blurring operation, a data cleansing operation, a data enrichment operation, a data aggregation operation, and a data storage operation. The data ingestion operation may include a retrieval or import of the data from various data sources for further processing or storage in a database or memory. The data normalization operation may include a data deduplication or normalization to remove redundancy and ensure that related data may be stored in the database or memory. The data blurring operation may include a data anonymization to remove personally identifiable information from the data or to make personal details impossible to identify from the data. The data cleansing operation may include a removal of incorrect, corrupted, incorrectly formatted, duplicate, or incomplete data points from the plurality of data records.

The data enrichment operation may include a collation of first party data and disparate data from multiple sources including internal data sources (e.g., the plurality of electronic device 104), third party data sources, or data aggregators. The data aggregation operation may include a summarization of the dataset and presentation of the summarized dataset for analysis. The data storage operation may include storage of data in the database or memory in a suitable format. The stored data may be indexed in the database or memory for fast retrieval. Further, in certain cases, the stored data may be hashed or encrypted in the database or memory for secure storage. The detailed implementation of the aforementioned data processing operations may be known to one skilled in the art, and therefore, a detailed description for the aforementioned data processing operations has been omitted from the disclosure for the sake of brevity.

At 406, analytics information may be generated. In an embodiment, the circuitry 202 may be configured to generate analytics information (i.e. associated with at least one of the plurality of data fields of the plurality of data records), based on an application of the trained ML model 106 on the acquired plurality of data records. In an embodiment, the circuitry 202 may be configured to apply the trained ML model 106 on the processed data, to further generate the analytics information associated with at least one of the plurality of data fields. The trained ML model 106 may receive the processed data as input and may classify and/or extract information in each of the plurality of data records for respective data fields (such as, demographic data fields related to users, device data fields associated with the plurality of electronic devices 104, content metadata fields associated with the media content shared, contextual data fields, interaction data fields related to the media content shared, or vehicular data fields).

The ML model 106 may be trained on the plurality of data fields described, for example, in FIGS. 3A-3F. Further, the trained ML model 106 may analyze the information in the plurality of data records for the plurality of data fields. Based on the analysis, the trained ML model 106 may generate the analytics information associated with at least one of the plurality of data fields. Examples of the generated analytics information associated with at least one of the plurality of data fields are described, for example, in FIGS. 5A-5E.

Thereafter, the circuitry 202 may be configured to control the generated analytics information. In an embodiment, the circuitry 202 may be configured to transmit the generated analytics information to an electronic device associated with content creators or distributors. In another embodiment, the circuitry 202 may control a display device (i.e. integrated within the server 102 or externally coupled to the server 102) to display the generated analytics information. For example, the generated analytics information may indicate, but is not limited to, demographic information of the plurality of users 110, an amount of the media content shared by the plurality of users 110, and information related to content metadata fields associated with the media content. The circuitry 202 may be configured to generate the analytics information based on information about different combination of data fields in the plurality of data records. For example, the circuitry 202 may generate the analytics information based on information related to a combination of demographic data fields, content metadata fields, and vehicular data fields of the plurality of data records. Examples of the analytics information generated based on the information for different combination of data fields are described, for example, in FIGS. 5A-5E. Such automatic generated analytics information based on the acquired data records (i.e. related to media content sharing interactions) may help the content creators, content distributers, artists, end users, and/or advertisers to derive meaningful and valuable insights from the plurality of data records, increase an engagement between artists/content creators and listeners (or viewers), and effectively target listeners (or viewers) for advertisement campaigns to further enhance media content creation/distribution/sales business.

FIGS. 5A-5F are diagrams that illustrate exemplary scenarios for generated analytics and recommendations, based on media content sharing interaction, in accordance with an embodiment of the disclosure. FIG. 5A is explained in conjunction with elements from FIGS. 1, 2, 3A-3F, and 4. With reference to FIG. 5A, there is shown an exemplary scenario 500A. The scenario 500A may include a textual and a graphical representation of the analytics information.

In an embodiment, the circuitry 202 may be configured to control the trained ML model 106 to determine a time duration of the media content at which a majority of users (i.e., related to the plurality of data records) perform the media content sharing interaction. The circuitry 202 may be configured to control (i.e. render, transmission, or storage, etc) the analytics information including the determined time duration of the media content. For example, the circuitry 202 may record a plurality of timestamps including a time duration of the media content at which media content sharing interactions are performed. The circuitry 202 may be further configured to determine the time duration of the media content at which a majority of users shared the media content, based on the application of the trained ML model 106 on the recorded plurality of timestamps. Thereafter, the circuitry 202 may be configured to generate the analytics information including the determined time duration of the media content. For example, in FIG. 5A, there is shown a graphical representation indicative of the analytics information including the determined time duration of the media content.

The graphical representation depicts that the majority of users performed the media content sharing interaction for a particular media content between 2.05-2.40 minutes of a 3 minutes total duration of media content (such as, a song). Further, there is shown in the FIG. 5A, for example, a text representation of the analytics information, which may include a message, such as, “Majority of listeners shared a song between 2:05-2:40. The verse during or prior to the period is the preferred part of the song”.

In an embodiment, the circuitry 202 may be configured to extract text information from a portion of the media content based on the determined time duration. The circuitry 202 may be configured to control (i.e. render, transmission, or storage) the analytics information including the extracted text information. The circuitry 202 may be configured to analyze the portion of the media content using natural language processing (NLP) techniques. For example, the circuitry 202 may employ NLP techniques to extract text information (such as keywords or key phrases) from the portion of the media content (i.e., the song, or podcast) shared by the majority of users. The extracted text information may indicate a preferred portion of the media content based on the determined time duration.

In an example, the majority of users (for example, listeners) may perform the media content sharing interaction (for example, shared a podcast) at the time duration between 11:20-11:55 minutes of the media content. This may indicate that the portion of the media content between 11:20-11:55 minutes may be preferred by or resonate with the majority of users. In another example, the majority of users (for example, listeners) may perform the media content sharing interaction (for example, shared a song) at the time duration between 2:05-2:40 minutes of the media content. This may indicate that the portion (such as the verse) of the media content played at 2:05-2:40 minutes was a preferred part of the media content mostly liked by the majority of users. Such analytics information may be valuable for content creators, or stakeholders, and may be used to further engage the majority of users. For example, the stakeholders, such as advertisers and sponsors may create targeted advertisements for insertion at the determined time duration. Further, the engagement with the users may be enhanced by creation of new episodes (like about a relevant topic as per time or location) or new songs, and launch of social media engagement campaigns based on the determined time duration at which the majority of users performed the media content sharing interactions as per the automated analysis of the plurality of data records by the disclosed server 102. It should be noted that the scenario 500A of FIG. 5A is for exemplary purpose and should not be construed for limiting the scope of the disclosure.

With reference to FIG. 5B, there is shown an exemplary scenario 500B. The scenario 500B may include a textual and a graphical representation of the generated analytics information. In an embodiment, the circuitry 202 may be configured to generate the analytics information based on information related to a combination of demographic data fields, content metadata fields, and vehicular data fields of the plurality of data records. In an embodiment, the circuitry 202 may be configured to apply the trained ML model 106 on the information in the plurality of data records related to the demographic data fields, the content metadata fields, and the vehicular data fields. Thereafter, the circuitry 202 may be configured to automatically generate the analytics information based on the application of the trained ML model 106. For example, in FIG. 5B, there are shown, pie-charts indicative of the analytics information based on the information related to the combination of the demographic data fields, the content metadata fields, and the vehicular data fields of the plurality of data records for media content sharing interaction associated with the media content (such as a rap music). The demographic data may indicate that a majority of the users who perform media content sharing interaction associated with the rap music may belong to an age group of, for example, 22-30 years. The vehicular data may indicate that the majority of the media content sharing interactions of the particular rap music may be performed when the user may be in the vehicle and the speed of the vehicle may be, for example, 65-75 mph. Further, the content metadata may indicate that the genre of the shared media content is a rap music and a media source associated with shared media content for the majority of users may be radio. Thus, the generated analytics information may indicate, for example, that the majority of users in the age group of 22-30 years may be more inclined towards the rap music, which may be played and shared mostly when they are travelling in the vehicle at the speed of 65-75 mph (i.e. high speed). Such analytics information automatically generated from the plurality of data records by the disclosed server 102 may provide an opportunity for the content creators and related stakeholders to promote a rap artist near highway or any geographical region near the highway. For example, in FIG. 5B, there is shown a text representation of the analytics information, which may include a message such as “People aged 22-30 years tend to share rap music when they are travelling between 65-75 mph”. Details of the demographic data fields, the content metadata fields, and the vehicular data fields of the plurality of data records are described, for example, in FIGS. 3A, 3B, and 3E. In another example, based on the application of the ML model 106, the server 102 may generate the analytic information, like the majority of males at the age group of 18-25 years located at the regions of eastern US (i.e. demographic data fields) shares the media content of a particular artist or a rock band (i.e. content metadata fields), when the volume setting (i.e. vehicular data fields) of the infotainment device of respective vehicles indicates a high volume (or higher than a threshold volume value).

In an embodiment, the circuitry 202 may be further configured to generate one or more recommendations based on the generated analytics information. For example, in FIG. 5B, there is shown a text representation of the recommendation that may include a message, such as, “promote a creator CPA campaign for rap artists in a geofence location near highway over radio”. It should be noted that the scenario 500B of FIG. 5B is for exemplary purpose and should not be construed for limiting the scope of the disclosure.

With reference to FIG. 5C, there is shown an exemplary scenario 500C. The scenario 500C may include, for example, a textual and a tabular representation of the analytics information. In an embodiment, the circuitry 202 may be configured to generate the analytics information based on information related to a combination of demographic data fields, content metadata fields, and contextual data fields of the plurality of data records. In an embodiment, the circuitry 202 may be configured to apply the trained ML model 106 on the information of the data records for the demographic data fields, the content metadata fields, and the contextual data fields. Thereafter, the circuitry 202 may be configured to generate the analytics information based on the application of the trained ML model 106. For example, in FIG. 5C, there are shown pie-charts indicative of the analytics information based on the information related to the demographic data, and a table indicative of the contextual data of the plurality of data records for media content sharing interaction associated with dance related music (i.e. content metadata field). The demographic data indicates that a majority of the users who perform the media content sharing interactions associated with dance music (i.e. content metadata field) may belong to an age group of 22-30 years.

As shown in FIG. 5C, the table indicative of the contextual data may include columns such as, a time of day, an ambient temperature, and whether it is raining or not (yes/no) when the media content sharing interactions are performed. The table may further include multiple rows, where each row may correspond to the contextual data related to users (such as, a “User 1”, “User 2”, ... and “User N”). As shown in the table, “Evening”, “Evening”, ... and “Noon” are provided as exemplary row values for the time of day. Further, “60° F.”, “58° F.”, ... and “88° F.” are provided as exemplary row values for the ambient temperature, and “Yes”, “Yes”, ... and “No” are provided as exemplary row values for the raining status. Such analytics information may indicate that the majority of users in the age group of 22-30 years (i.e. demographic data field) may be more inclined towards the dance music (i.e. content metadata field), which may be played and shared mostly when there is a pleasant weather and raining (i.e. context data field). This may provide a business insight and/or an opportunity to the content creators, distributors, and/or the relevant stakeholders to improve content engagement with the majority of users on a pleasant raining evening. For example, in FIG. 5C, there is shown a textual representation of the analytics information, which may include a message such as “People aged 22-30 years tend to share dance music at evening on a rainy day”.

Details of the demographic data fields, content metadata fields, and contextual data fields of the plurality of data records is described, for example, in FIGS. 3A, 3B, and 3D. In another example, the analytic information generated based on the combination of the demographic data fields, content metadata fields, and contextual data fields may indicate that, for example, the majority of people in United States (i.e. demographic data fields) share Christmas-related playlists (i.e. content metadata fields) in 3^{rd} and 4^{th} week of a month of December (i.e. contextual data fields). It should be noted that the scenario 500C of FIG. 5C is for exemplary purpose and should not be construed for limiting the scope of the disclosure.

With reference to FIG. 5D, there is shown an exemplary scenario 500D. The scenario 500D may include a textual and a graphical representation of the analytics information. In an embodiment, the circuitry 202 may be configured to apply the trained ML model 106 on the plurality of data records to determine first information indicating a number of times media content is shared over a period of time. For example, a user 1 may perform media content sharing interaction with a user 2, via a digital streaming platform (such as, a social media platform or a media content streaming platform). In other words, a user may share media content (such as work of an artist or a podcaster) with another user that may be a unique listener or a fan of the artist (or the podcaster). The circuitry 202 may be configured to analyze (using the trained ML model 106) each media content sharing interaction (i.e. data records) performed for the media content over the period of time (for example in certain days/weeks/months). Thereafter, based on the analysis the circuitry 202 may be configured the determine the first information.

For example, the circuitry 202 may be configured to control (i.e. transmission, rendering, or storage) the analytics information including the first information. Such analytics information may include a sharing rate indicative of a number of users sharing the media content. In an instance, the sharing rate may indicate a number of users sharing the media content after a launch or release of the media content. This may enable the content creator, distributor, or end user to predict a success of a launch or release of the media content. Based on such prediction, investment may be made to improve sales through advertisements and promotional campaigns.

In an embodiment, the circuitry 202 may be configured to apply the trained ML model 106 on the plurality of data records to determine second information indicating a number of times the media content is shared, via a particular content sharing application. For example, a user 1 may perform media content sharing interaction with a user 2, via the particular content sharing application. In other words, a user may share media content (such as work of an artist or a podcaster) with another user that may be a unique listener or a fan of the artist or the podcaster, using the particular content sharing application. The circuitry 202 may be configured to analyze each media interaction (i.e. data records) performed for the media content over the period of time to determine the second information.

In an embodiment, the circuitry 202 may be further configured to determine the first information and the second information based on geo-location information included in at least one of: demographic data fields or contextual data fields of the plurality of data records. For example, the circuitry 202 may be configured to apply the trained ML model 106 on the plurality of data records to determine the first information indicating a number of times media content is shared over a period of time in a particular geo-location, and the second information indicating a number of times the media content is shared in the particular geo-location, via the particular content sharing application.

In an embodiment, the circuitry 202 may be configured to determine a ratio of the determined first information and the determined second information. The circuitry 202 may be configured to control (i.e. transmission, rendering, or storage) the analytics information including the determined ratio. The ratio may correspond to shares-per-stream that may be indicative of a number of times the media content is shared, via the content sharing application (i.e., the second information), out of a total number of times the media content is shared (i.e., the first information). For example, a song of an artist may be shared a total of 30000 times in a first week of a launch of the song. Out of the total 30000 number of shares, the song may be shared via the particular content sharing application 1600 times within the same first week. In such case, the ratio may be determined as 0.053 or 5.3%. Such determined ratio about the particular content sharing application, may indicate how much that particular application is trending or successful among the users for performing content sharing interactions. Such content sharing application may be further enhanced with more engaging services, media contents and advertisements.

For example, in FIG. 5D, there is shown a table indicative of the interaction data related to the media content shared. As shown in FIG. 5D, the table indicative of the interaction data may include columns such as, but not limited to, a number of streams, an album, a song, a day of share, and a time of share. The table may further include multiple rows, where each row may correspond to the interaction data related to the media content shared of multiple artists (such as, an “Artist 1”, an “Artist 2”, ... and “Artist N”). As shown in the table, “30000”, “20000”, ... and “40000” are provided as exemplary row value for the number of streams. Further, “A”, “B”, ... and “C” are provided as exemplary row values for the album name, and “X”, “Y”, ... and “Z” are provided as exemplary row values for the song title. Further, “Friday”, “Wednesday”, ... and “Sunday” are provided as exemplary row values for the day of share, and “12 PM”, “2 PM”, ... and “5 PM” are provided as exemplary row values for the time of share.

For example, in FIG. 5D, there is shown, a pie-chart indicative of the analytics information generated based on the data records indicating the media content sharing interactions using a particular application (like “Application 1” as shown in FIG. 5D). In an embodiment, the particular application may be related to a product (such as a vehicle). The displayed analytics information may indicate a number of shares of the media content (say of an Artist 1) using the particular content sharing application or when the users are inside respective vehicles (i.e. for example, such media content shares are referred herein as in-vehicle shares). For example, the pie-chart of the analytics information may indicate that “1600” of the users performed in-vehicle shares of the media content of Artist 1 or used the particular application (like Application 1) to perform the media content sharing. For example, in FIG. 5D, there is shown a textual representation of the analytics information, which may include a message, such as, “1600 people shared the song of Artist 1 on Application 1. This is a 5.3% share/stream ratio”. Further, the generated analytics information indicating the first information, the second information, and/or the determined ratio may be based on the geo-location information, such as “Share/stream ratio is higher for Artist 1 in Dallas, TX and Houston, TX”, as shown (for example) in FIG. 5D.

For example, the plurality of data records indicates that first media content and second media content associated with an Artist 1, and an Artist 2, respectively, were launched on same date-time (for example at 12:00 am on a Friday of a particular month). The analytics information generated from such data records may indicate that a number of shares for the first media content may be 10000 more than a number of shares for the second media content, at end of the first week of the launch. Further, the analytics information may indicate the ratio (i.e. shares-per-stream ratio) of the determined first information and the second information associated with the sharing of the first media content, and may further indicate that the shares-per-stream ratio for the first media content (of Artist 1) may be higher in a particular geo-location (such as in Dallas, Texas (TX) and Houston, TX). Such generated analytics information (indicating the shares-per-stream ratio for different media content for different geo-locations) may allow the content creators/distributors to run targeted advertisement campaigns in particular geo-locations (such a Dallas, TX, and Houston) after certain days/weeks of the launch, in order to promote the first media content (i.e. related to Artist 1) and to outpace the competitor (such as Artist 2).

In an embodiment, the circuitry 202 may be configured to generate one or more recommendations based on the generated analytics information. For example, in FIG. 5D, there is shown a textual representation of the recommendation that may include a message, such as, “Use Ad spend for promotion in Texas to outpace the competitor”. It should be noted that the scenario 500D of FIG. 5D is for exemplary purpose and should not be construed for limiting the scope of the disclosure.

In an embodiment, the circuitry 202 may be configured to analyze a user behavior based on the media content sharing interactions indicated by the plurality of data records. For example, a user may listen to certain media content associated with a first artist on a radio station and further share the particular media content with other users or listen to similar media content. In such case, the circuitry 202 may generate the analytics information including information about such media content that may be useful for the content creator (or podcasters) to make the media content more engaging and improve interaction with the users. For example, the content creators (or podcasters) may create a dedicated radio station associated with a popular artist including the media content of similar genre by other artists as well.

With reference to FIG. 5E, there is shown an exemplary scenario 500E. The scenario 500E may include a textual and/or an image representation of the analytics information. For example, in FIG. 5E, there is shown an image representation of the demographic data related to the users on a map of a country, such as, the United States of America. The image representation may represent an audience map for an artist ‘A’ for different designated market areas. For example, the determined ratio of the first information and the second information related to the media content sharing interactions in Mideastern United States (US), pacific northwest US, southwestern US, and southcentral region of the US may be determined as 73.8%, 8.5%, 11.8%, and 5.9% respectively, as shown in FIG. 5E.

In an embodiment, the circuitry 202 may be configured to determine a media source (i.e. associated with shared media content) and geo-location information related to the determined media source, based on the application of the trained ML model 106 on the acquired plurality of data records. Thereafter, the circuitry 202 may be configured to control (i.e. transmission, rendering, or storage) the analytics information including the determined media source and the determined geo-location information. For example, the content creators may launch the first media content (such a song of a particular artist) on multiple streaming platforms such as, radio, digital platforms, or internet applications, at different geo-locations. However, a number of shares as per the media content sharing interactions may be different for each media source based on the different geo-locations. The media source may include, for example, but is not limited to, an editorial playlist, a curated playlist, or a radio station, on which the media content sharing interactions related to the first media content may be performed by the plurality of users 110. For example, in FIG. 5E, there is shown a textual representation of the analytics information, which may include a message such as, “18-22 years old people in Mideastern United States share Artist A’s new song the most when discovering it on a radio station.” The circuitry 202 may be configured to generate such analytics information and automatically provide recommendations for the content creators, advertisers, sponsors, and other stakeholders to improve engagement and business with the users or listeners of different demographic profiles and geographic locations of a region.

In an embodiment, the circuitry 202 may be configured to apply the trained ML model 106 on the plurality of data records. The circuitry 202 may be further configured to determine at least one of: an artist, a composer, or a podcaster of the media content and an amount of sharing interactions for the media content (i.e. related to the artist, the composer, or the podcaster) based on the application of the trained ML model 106. Such information may be determined from the content metadata associated with the media content shared, and the interaction data related to the media content shared. Thereafter, the circuitry 202 may be configured to control (i.e. transmission, rendering, or storage) the analytics information including the determined at least one of: the artist, the composer, or the podcaster of the media content, and the determined amount of sharing interactions for the media content. Such analytics information may be helpful to promote local content creators, or new/small artists. For example, there may be a plurality of unknown artists in different geographical regions, and a well-known content creator may be looking to invest in such new talents. In such a case, the generated analytics information may include the first information associated with sharing of the media content, growth of the artist on a social media platform, and the like. Such analytics information may be helpful to derive meaningful insights, in order to acquire and invest in new talents. In an example, the circuitry 202 may generate the analytics information indicative of information that “Most of the people in Atlanta, GA and Miami, FL shared a new song of a new Artist (i.e. Artist A) the most in comparison to other artists (say of same genre and other geo-locations). It should be noted that the scenario 500E of FIG. 5E is for exemplary purpose and should not be construed for limiting the scope of the disclosure.

It may be further noted that all the exemplary scenarios (discussed in FIGS. 5A-5E) about the analytic information and recommendations are presented merely as examples. Based on recorded or run-time data related to different combinations of data fields (i.e. demographic of users, content metadata, contextual data, vehicular data, device related data, and interaction data), the disclosed server 102 may automatically generate valuable insights (as analytic information) which may effectively assist or recommend different stackholders (i.e. related to media content) to take appropriate decisions for business expansion (like related to content creation, research, hiring, training, investment, broadcasting, marketing, promotions, and/or sales.

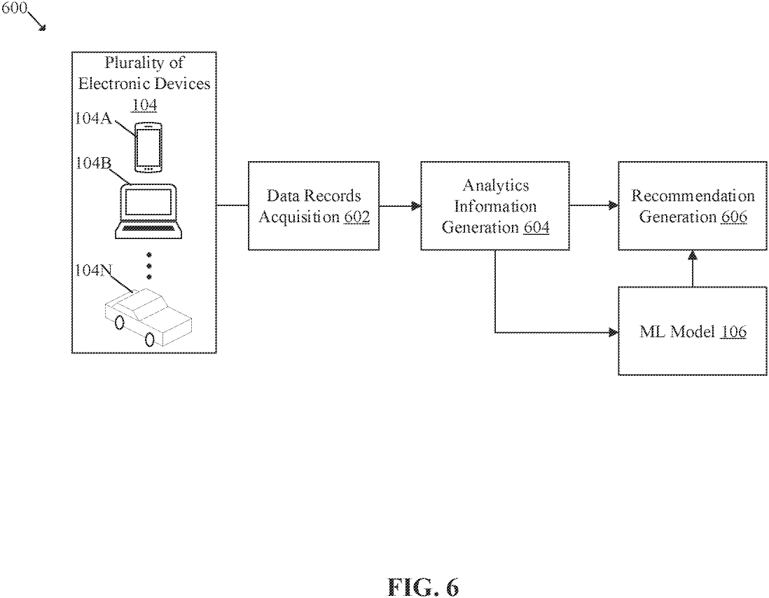

FIG. 6 is a diagram that illustrates exemplary operations for recommendations generation based on the analytics information, in accordance with an embodiment of the disclosure. FIG. 6 is explained in conjunction with elements from FIGS. 1, 2, 3A-3F, 4 and 5A-5E. With reference to FIG. 6, there is shown a block diagram 600 that illustrates exemplary operations from 602 to 606. The exemplary operations may be executed by any computing system, for example, by the server 102 of FIG. 1 or by the circuitry 202 of FIG. 2.

At 602, data records may be acquired. In an embodiment, the circuitry 202 may be configured to acquire, from the plurality of electronic devices 104, a plurality of data records, each including information about a plurality of data fields. Each of the plurality of data records may correspond to media content sharing interaction, as described, for example, in FIG. 4 (at 402).

At 604, analytics information may be generated. In an embodiment, the circuitry 202 may be configured to generate analytics information associated with at least one of the plurality of data fields of the plurality of data records, based on an application of the trained ML model 106 on the acquired plurality of data records, as described, for example, in FIG. 4 (at 406) and 5A-5E.

At 606, recommendations may be generated. In an embodiment, the circuitry 202 may be configured to automatically generate one or more recommendations based on an application of the trained ML model 106 on the generated analytics information. Thereafter, the circuitry 202 may be configured to control (i.e. transmission, rendering, or storage) the generated one or more recommendations. By way of example, and not limitation, the generated one or more recommendations may be related to advertisement and indicate at least one of: geo-location information, demographic information of users, a time period, a particular day of a month, vehicular information, weather information, or information related to one of the plurality of electronic devices, for the advertisement. In an embodiment, the generated one or more recommendations may be generated for the content creators (such as music creators, or podcasters), distributors, and related sales/marketing teams. Therefore, the circuitry 202 of the server 102 may be further configured to transmit the generated recommendations to different electronic devices associated with the content creators (such as music creators, or podcasters), distributors, and the related sales/marketing teams.

In an embodiment, the generated one or more recommendations may indicate, but are not limited to, a portion of the media content to be used for advertisement, a time period associated with the advertisement, a geolocation associated with the advertisement, text information to be used for the advertisement, another media content to be used for the advertisement, or a collaboration between one or more artists of the media content. The portion of the media content to be used for the advertisement may include a portion of the media content that may be shared by the majority of users. For example, the content creators may employ the portion of the media content to promote the media content and engage with the users via different streaming platforms or social media posts. In an instance, an artist or a podcaster may create posts (such as a post, a story, or a live event) on social media websites based on the portion of the media content. The determination of the portion of the media content is described, for example, in FIG. 5A.

The time period associated with the advertisement may include a time of the day or a day of the week when the majority of media content sharing interactions are performed. Thus, the generated recommendation information for the content creators may indicate same or nearby time period for the launch of the advertisement to further promote the media content or related artists. The geolocation associated with the advertisement may correspond to a geographical region associated with the majority of users who performed the media content sharing interactions. In an instance, an artist or a podcaster may plan a launch of their upcoming media content, or a promotional tour based on the determined geolocation (like a city, town, state, province, country). The determination of the geolocation associated with the advertisement is described for example, in FIGS. 5B and 5E.

The text information to be used for the advertisement may include a text information (such as lyrics, a verse, or a quote) associated with the portion of the media content that may be shared by the majority of users. In an instance, an artist or a podcaster may create posts (such as a post, lyrics, or a story,) on social media websites based on the text information. The determination of the text information is described, for example, in FIG. 5A. Such text information (i.e. preferred part of the media content) may not only be used for promoting the media content, but also for merchandising products.

Another media content to be used for the advertisement, may include, but is not limited to, a music video for a song, or a live show for an artist or a podcaster. The collaboration between one or more artists of the media content may indicate collaboration within artists of same or similar genre to improve interaction among the users and promote the artists. The collaboration may further indicate a musical company to organize an event including multiple artists (say of similar genre) for whom the media content sharing interactions are more within a particular time or in a particular geo-location. In an example, the recommendation may indicate re-launch of media content associated with an artist or a podcaster with a featured artist (who may be popular in a particular geolocation or digital streaming platform) when the majority of media content sharing interactions performed during a verse of the featured artist. In another example, the recommendation may indicate generation of a curated playlist associated with an artist or podcaster based on the most shared media content (such as a song). In an embodiment, the one or more recommendations may be generated based on a comparison of media content with other media contents such that the two media contents may have a similar genre, and that may be launched at a similar time period. In an embodiment, the one or more recommendations may be generated based on a comparison of a time duration of the media content at which the majority of users perform the media content sharing.

In an embodiment, the one or more recommendations may be generated based on a demographic data. For example, the circuitry 202 may be configured to generate personalized one or more recommendations based the demographic data related to the users. Examples of the one or more recommendations may include, but are not limited to, a content sharing application associated with the advertisement, an age group associated with the advertisement, or the demographic and contextual data associated with the advertisement.

In an embodiment, the one or more recommendations may be generated for advertisers who may use a particular content sharing application (i.e. installed or configured on the corresponding electronic device). For example, the one or more recommendations for such advertisers may include, but are not limited to, a geolocation where certain media content may be shared the most or more frequently (i.e. the same geo-location may be used for the target advertisements), a demographic profile of users who shared the particular media content (i.e. the same demographics of users may be targeted for relevant advertisement), or days of week/ times of day/ temperature/ weather conditions (such as, whether it is raining or not) when the media content may be shared the most (i.e. the same time/days/weather conditions may be used for the advertisement). The one or more recommendations may also include, but are not limited to, makes and models of vehicles from which the media content may be shared the most (and the same vehicle models/makes may be used more for the target marketing of the media content), astrological signs of the users who share the media content the most, sound/video settings of the infotainment systems or electronic devices in the vehicles associated with most common in-vehicle content sharing, or the operating system, the mobile carriers, and the electronic devices that may be used for sharing of the media content. Such recommendation information may assist the advertiser to develop and/or publish appropriate advertisements based on the recommendation information, to further enhance the business related to the media content and related products/services.

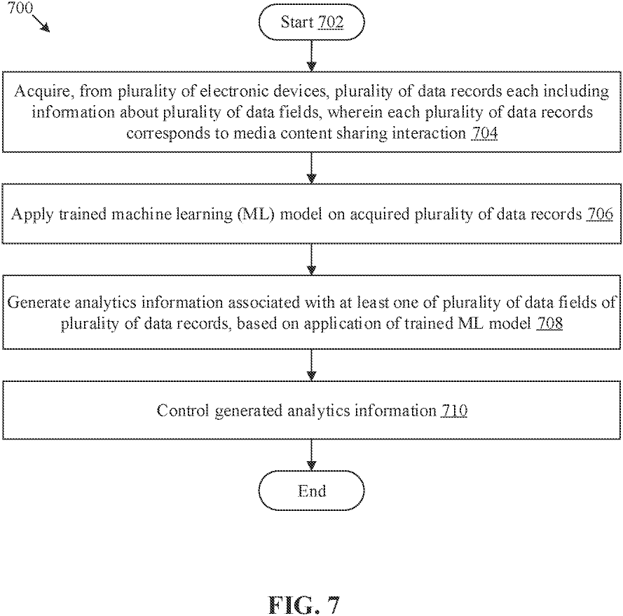

FIG. 7 is a flowchart that illustrates exemplary method for analytics and recommendation generation based on media content sharing interaction, in accordance with an embodiment of the disclosure. FIG. 7 is explained in conjunction with elements from FIGS. 1, 2, 3A-3F, 4, 5A-5E, and 6. With reference to FIG. 7, there is shown a flowchart 700. The method illustrated in the flowchart 700 may be executed by any computing system, such as by the server 102 or the circuitry 202. The method may start at 702 and proceed to 704.

At 704, a plurality of data records may be acquired. In an embodiment, the circuitry 202 may be configured to acquire, from a plurality of electronic devices (such as the plurality of electronic devices 104), the plurality of data records each, including information about a plurality of data fields. Each of the plurality of data records may correspond to a media content sharing interaction. The acquisition of the plurality of data records is described, for example, in FIG. 4 (at 402).

At 706, a trained machine learning (ML) model may be applied. In an embodiment, the circuitry 202 may be configured to apply the trained ML model 106 on the acquired plurality of data records. The application of the ML model 106 is described, for example, in FIG. 4.

At 708, analytics information may be generated. In an embodiment, the circuitry 202 may be configured to automatically generate the analytics information associated with at least one of the plurality of data fields of the plurality of data records, based on the application of the trained ML model 106. The generation of the analytics information is described, for example, in FIG. 4 (406) and 5A-5E.

At 710, the generated analytics information may be controlled. In an embodiment, the circuitry 202 may be configured to control (i.e. transmission, rendering, or storage) the generated analytics information. The control of the generated analytics information is described, for example, in FIGS. 5A-5E. Control may pass to end.

Although the flowchart 700 is illustrated as discrete operations, such as 704, 706, 708, and 710 the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer-readable storage medium configured to store instructions that, in response to being executed, causes a server (such as, server 102) to perform operations that include acquisition, from a plurality of electronic devices (such as plurality of electronic device 104), a plurality of data records, each including information about a plurality of data fields. Each of the plurality of data records may correspond to a media content sharing interaction. The operations may further include application of a trained machine learning (ML) model (such as, the ML model 106) on the acquired plurality of data records. The operations may further include generation of analytics information associated with at least one of the plurality of data fields of the plurality of data records, based on the application of the trained ML model 106. The operations may further include control of the generated analytics information.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. A server, comprising:
circuitry which:
acquires, from a plurality of electronic devices, a plurality of data records each including information about a plurality of data fields, wherein each of the plurality of data records corresponds to media content sharing interaction;
applies a trained machine learning (ML) model on the acquired plurality of data records;
generates analytics information associated with at least one of the plurality of data fields of the plurality of data records, based on the application of the trained ML model; and
controls the generated analytics information.

2. The server according to claim 1, wherein the plurality of data fields comprises at least one of: demographic data fields related to users associated with the plurality of electronic devices, device data fields associated with the plurality of electronic devices, content metadata fields associated with the media content shared, contextual data fields, interaction data fields related to the media content shared, or vehicular data fields.

3. The server according to claim 1, wherein the circuitry further:
executes one or more data processing operations on the acquired plurality of data records, to generate processed data; and
applies the trained ML model on the processed data, to further generate the analytics information associated with at least one of the plurality of data fields.

4. The server according to claim 1, wherein the generated analytics information indicates demographic information of a plurality of users, an amount of the media content shared by the plurality of users, and information related to content metadata fields associated with the media content.

5. The server according to claim 1, the circuitry further:
controls the trained ML model to determine a time duration of the media content at which a majority of users, related to the plurality of data records, performs the media content sharing interaction; and
controls the analytics information including the determined time duration of the media content.

6. The server according to claim 5, wherein the circuitry further:
extracts text information from a portion of the media content based on the determined time duration; and
controls the analytics information including the extracted text information.

7. The server according to claim 1, wherein the circuitry further generates the analytics information based on information related to a combination of demographic data fields, content metadata fields, and vehicular data fields of the plurality of data records.

8. The server according to claim 7, wherein the information related to the vehicular data fields indicates at least one of: a state of a vehicle in which the media content sharing interaction performed, model of the vehicle, speed of the vehicle, geo-location information of the vehicle, or setting information associated with an infotainment device of the vehicle.

9. The server according to claim 1, wherein the circuitry further generates the analytics information based on information related to a combination of demographic data fields, content metadata fields, and contextual data fields of the plurality of data records.

10. The server according to claim 1, wherein the circuitry further:
applies the trained ML model on the plurality of data records to determine first information indicating a number of times the media content is shared over a period of time;
applies the trained ML model on the plurality of data records to determine second information indicating a number of times the media content is shared, via a content sharing application;
determines a ratio of the determined first information and second the determined information; and
controls the analytics information including the determined ratio.

11. The server according to claim 10, wherein the circuitry further determines the first information and the second information based on geo-location information included in at least one of: demographic data fields or contextual data fields of the plurality of data records.

12. The server according to claim 1, wherein the circuitry further:
determines a media source, associated with shared media content, and geo-location information related to the determined media source, based on the application of the trained ML model on the acquired plurality of data records; and
controls the analytics information including the determined media source and the determined geo-location information.

13. The server according to claim 1, wherein the circuitry further:
applies the trained ML model on the plurality of data records;
determines at least one of: an artist, a composer, or a podcaster of the media content and an amount of sharing interactions for the media content based on the application of the trained ML model; and
controls the analytics information including the determined at least one of: the artist, the composer, or the podcaster of the media content, and the determined amount of sharing interactions for the media content.

14. The server according to claim 1, wherein the circuitry further:
applies the trained ML model on the generated analytics information;
generates one or more recommendations based on the application of the trained ML model on the generated analytics information; and
controls the generated one or more recommendations.

15. The server according to claim 14, wherein the generated one or more recommendations indicate at least one of:
a portion of the media content to be used for advertisement,
a time period associated with the advertisement,
a geolocation associated with the advertisement,
text information to be used for the advertisement,
another media content to be used for the advertisement, or
a collaboration between one or more artists of the media content.

16. The server according to claim 14, wherein the generated one or more recommendations are related to advertisement and indicate at least one of: geo-location information, demographic information of users, a time period, a particular day of a month, vehicular information, weather information, or information related to one of the plurality of electronic devices, for the advertisement.

17. A method, comprising:
in a server:
acquiring, from a plurality of electronic devices, a plurality of data records each including information about a plurality of data fields, wherein each of the plurality of data records corresponds to media content sharing interaction;
applying a trained machine learning (ML) model on the acquired plurality of data records;
generating analytics information associated with at least one of the plurality of data fields of the plurality of data records, based on the application of the trained ML model; and
controlling the generated analytics information.

18. The method according to claim 17, wherein the plurality of data fields comprises at least one of: demographic data fields related to users associated with the plurality of electronic devices, device data fields associated with the plurality of electronic devices, content metadata fields associated with the media content shared, contextual data fields, interaction data fields related to the media content shared, or vehicular data fields.

19. The method according to claim 17, further comprising:
applying the trained ML model on the generated analytics information;
generating one or more recommendations based on the application of the trained ML model on the generated analytics information; and
controlling the generated one or more recommendations.

20. A non-transitory computer-readable storage medium configured to store instructions that, in response to being executed, causes a server to perform operations, the operations comprising:
acquiring, from a plurality of electronic devices, a plurality of data records each including information about a plurality of data fields, wherein each of the plurality of data records corresponds to media content sharing interaction;
applying a trained machine learning (ML) model on the acquired plurality of data records;
generating analytics information associated with at least one of the plurality of data fields of the plurality of data records, based on the application of the trained ML model; and
controlling the generated analytics information.
